(19) United States
(12) Patent Application Publication
(10) Pub. No.: US 2026/0259958 A1
(43) Pub. Date: Sep. 3, 2026

(54) TRAINING METHOD AND APPARATUS FOR URBAN UNDERGROUND GAS LEAKAGE IDENTIFICATION MODEL

(71) Applicant: BEIJING GLOBAL SAFETY TECHNOLOGY CO., LTD., Beijing (CN)

(72) Inventors: Tao Chen, Beijing (CN); Zhanhui Sun, Beijing (CN); Zhipeng Li, Beijing (CN); Jiakun Dai, Beijing (CN); Ning Wei, Beijing (CN); Qi Yao, Beijing (CN); Xiaoli Yan, Beijing (CN)

(73) Assignee: BEIJING GLOBAL SAFETY TECHNOLOGY CO., LTD., Beijing (CN)

(21) Appl. No.: 18/718,408

(22) PCT Filed: Dec. 27, 2022
(86) PCT No.: PCT/CN2022/142551

§ 371 Date: Jun. 10, 2024

(30) Foreign Application Priority Data
Dec. 29, 2021 (CN) 202111642977.X

(51) Int. Cl. G06F 18/214; F17D 5/02; G06F 18/22

(52) U.S. Cl. CPC G06F 18/214; F17D 5/02; G06F 18/22

(57) ABSTRACT

A method for training a model of identifying urban underground gas leakage includes: acquiring a first methane concentration sequence to be labeled from a timing database; determining a target segment corresponding to an abnormal change of a methane concentration from the first methane concentration sequence; obtaining a methane concentration change feature by performing feature extraction on the target segment; acquiring a target real methane concentration sequence matching the methane concentration change feature from a real gas leakage case library; taking a label corresponding to the target real methane concentration sequence as label data of the target segment; obtaining an updated real gas leakage case library by adding the target segment and the label data to the real gas leakage case library; and training the model of identifying gas leakage according to each methane concentration sequence and corresponding label data in the updated real gas leakage case library.

### CROSS-REFERENCE TO RELATED APPLICATIONS

This application is the U.S. National Stage Application of International Application No. PCT/CN2022/142551, filed on Dec. 27, 2022, which is based on and claims priority to Patent Application No. 202111642977.X, filed on Dec. 29, 2021, the entire contents of which are incorporated herein by reference.

### TECHNICAL FIELD

The present disclosure relates to the field of Artificial Intelligence & Internet of Things (AIoT) and the field of gas safety, and specifically to a method and an apparatus for training a model of identifying urban underground gas leakage, an electronic device, a storage medium, a computer program product and a computer program.

### BACKGROUND

At present, an underground gas pipe network is still an important part of the city, which is of vital importance for intelligent monitoring of urban gas. In the related art, whether gas is leaked is identified by analyzing a correlation between a methane concentration and a temperature, for example, a correlation coefficient between the methane concentration and the temperature. However, a large number of false alarms and leaked alarms may occur in the existing method.

### SUMMARY

According to a first aspect of the disclosure, a method for training a model of identifying urban underground gas leakage is provided. The method includes: acquiring a first methane concentration sequence to be labeled from a timing database; determining a target segment corresponding to an abnormal change of a methane concentration from the first methane concentration sequence; obtaining a methane concentration change feature by performing feature extraction on the target segment; acquiring a target real methane concentration sequence matching the methane concentration change feature from a real gas leakage case library; taking a label corresponding to the target real methane concentration sequence as label data of the target segment; obtaining an updated real gas leakage case library by adding the target segment and the label data to the real gas leakage case library; and training the model of identifying gas leakage according to each methane concentration sequence and corresponding label data in the updated real gas leakage case library.

According to a second aspect of the disclosure, an electronic device is provided. The electronic device includes a memory, a processor, and a computer program stored on the memory and executable by the processor. The processor is configured to acquire a first methane concentration sequence to be labeled from a timing database; determine a target segment corresponding to an abnormal change of a methane concentration from the first methane concentration sequence; obtain a methane concentration change feature by performing feature extraction on the target segment; acquire a target real methane concentration sequence matching the methane concentration change feature from a real gas leakage case library; take a label corresponding to the target real methane concentration sequence as label data of the target segment; obtain an updated real gas leakage case library by adding the target segment and the label data to the real gas leakage case library; and train the model of identifying gas leakage according to each methane concentration sequence and corresponding label data in the updated real gas leakage case library.

According to a third aspect of embodiments of the disclosure, a non-transitory computer-readable storage medium storing a computer program is provided. When the program is executed by the processor, the method for training the model of identifying urban underground gas leakage according to the first aspect of the disclosure is implemented.

Additional aspects and advantages of embodiments of the disclosure will be given in part in the following descriptions, become apparent in part from the following descriptions, or be learned from the practice of the embodiments of the disclosure.

### BRIEF DESCRIPTION OF THE DRAWINGS

The above and/or additional aspects and advantages of the present disclosure will become obvious and easy to understand from the following description of the embodiments in conjunction with the accompanying drawings,

FIG. 1 is a flowchart illustrating a method for training a model of identifying urban underground gas leakage according to an embodiment of the present disclosure.

FIG. 2 is a flowchart illustrating a technology for a gas monitoring data flow access according to an embodiment of the disclosure.

FIG. 3 is a diagram illustrating unit segments whose methane concentration abnormally changes according to an embodiment of the present disclosure.

FIG. 4 is a diagram illustrating a real gas leakage slice according to an embodiment of the present disclosure.

FIG. 5 is a flowchart illustrating analysis and identification of the urban underground gas leakage based on an AIoT technology according to an embodiment of the present disclosure.

FIG. 6 is a flowchart illustrating a method for training a model of identifying urban underground gas leakage according to another embodiment of the present disclosure.

FIG. 7 is a flowchart illustrating an apparatus for training a model of identifying urban underground gas leakage according to an embodiment of the present disclosure.

FIG. 8 is a structural diagram illustrating an electronic device according to an embodiment of the present disclosure.

### DETAILED DESCRIPTION

Embodiments of the disclosure will be described in detail below and examples of embodiments are illustrated in the drawings. The same or similar elements and the elements having the same or similar functions are denoted by same or similar reference numerals throughout the drawings. Embodiments described herein with reference to drawings are explanatory, serve to explain the disclosure, and are not construed to limit embodiments of the disclosure.

A method and an apparatus for training a model of identifying urban underground gas leakage, an electronic device, a storage medium, a computer program product, and a computer program in embodiments of the disclosure are described referring to attached drawings.

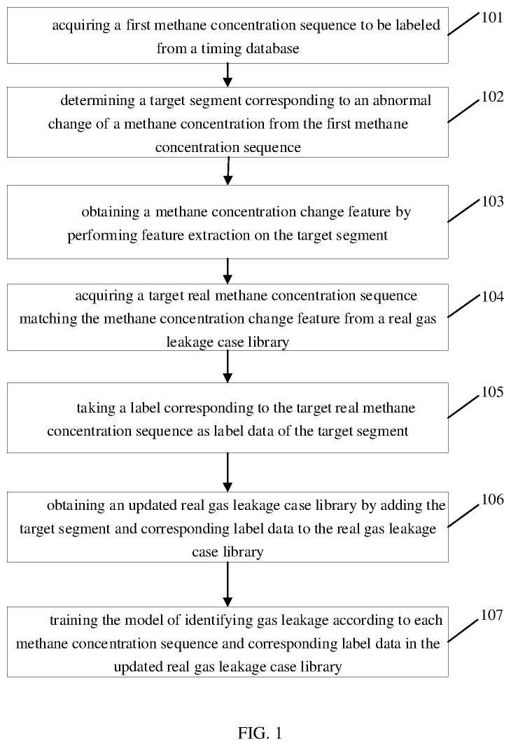

FIG. 1 is a flowchart illustrating a method for training a model of identifying urban underground gas leakage according to an embodiment of the present disclosure. As illustrated in FIG. 1, the method mainly includes steps 101 to 107.

At step 101, a first methane concentration sequence to be labeled is acquired from a timing database.

The timing database may store gas related data acquired by an intelligent hardware device in an urban underground gas pipe network.

As an example implementation, the intelligent hardware device may be arranged in an inspection well near a gas pipe section in the urban underground gas pipe network. The intelligent hardware device monitors gas conditions around the gas pipe section, and sends gas related data to a gas big data base platform. The gas big data platform stores the gas related data received in a timing database ‘TDengine’.

The gas related data may include gas dynamic monitoring data and gas static data. The gas dynamic monitoring data may include, but is not limited to, a time, a methane concentration, a temperature, a humidity, and a device state. The gas static data may include but is not limited to an inspection well number, an inspection well type, an inspection well address, a device number, and an installation date.

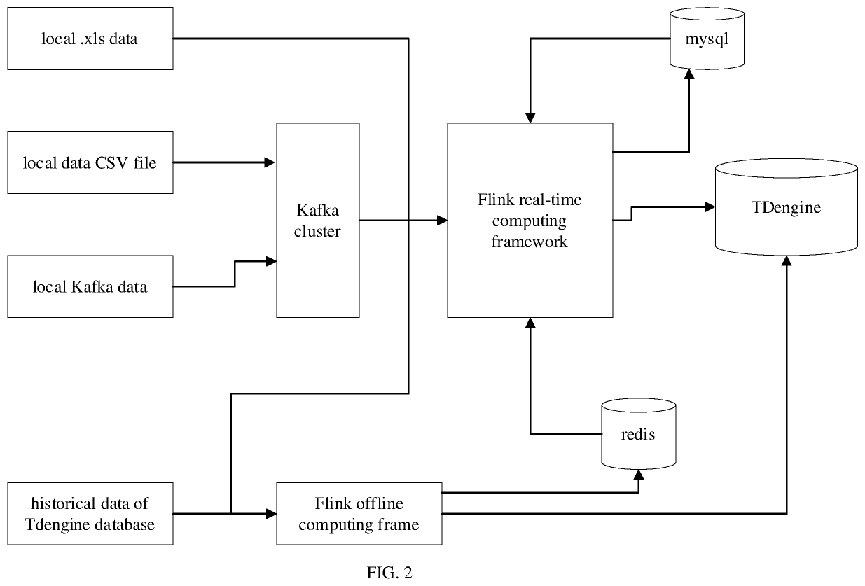

In some embodiments, as shown in FIG. 2, a local .xls file, a local data CSV file, and local Kafaka data in the gas dynamic monitoring data may be input into a high-throughput distributed publish-subscribe message system (e.g., Kafka cluster) for processing. The gas dynamic monitoring data is converted into data of the same data type and transmitted to a real-time computing frame Flink for computing, so as to be stored in a relational database Mysql and a timing database. Meanwhile, historical data of the timing database TDengine in the gas static monitoring data is input into an offline computing frame Flink for processing, to transmit and store the processed gas static data into the timing database, and the historical data of the TDengine may be calculated in the real-time computing frame Flink in combination with a remote dictionary service Redis, so as to be stored in the relational database Mysql.

At step 102, a target methane concentration sequence segment corresponding to an abnormal change of a methane concentration is determined from the first methane concentration sequence.

In embodiments of the disclosure, a plurality of methane concentration sequence segments are obtained by segmenting the first methane concentration sequence according to a methane concentration interval corresponding to a preset risk level, and whether the methane concentration changes is determined in combination with a risk level change condition of a methane concentration sequence of each segment, and when it is determined that the methane concentration changes, the target methane concentration sequence segment corresponding to the abnormal change of the methane concentration may be determined.

The methane concentration reaches an alarm level corresponding to a certain risk level. For example, a sequence with a methane concentration below 1% is set to no alarm, a sequence with a methane concentration between 1%-4% may be set to a third-level alarm, a sequence with a methane concentration between 4%-10% may be set to a second-level alarm, and a sequence with a methane concentration above 10% may be set to a first-level alarm. Specifically, methane concentration values may be replaced by different risk levels such as 0, 1, 2, 3 according to intervals of [0-1%], [1-4%], [4-10%], [10%--] , and a coded data sequence may be obtained, so that sub-segments with the risk levels 0, 1, 2, 3 respectively are obtained for different coded data sequences by segmenting according to different risk levels.

In some embodiments, sub-segments with the different risk levels 0, 1, 2, 3 are divided respectively. For example, a process of diving the sub-segments may be that, it is first determined whether there are burrs in each sub-segment. When a number of the occurred burrs is less than a threshold, the burrs are classified into risk levels corresponding to a majority of sampling points, and when the number of the occurred burrs is greater than the threshold, the risk levels corresponding to the burrs are taken as independent sub-slices. For example, a threshold of the number of the burrs may be but not limited to 5.

Compared with most sampling points whose methane concentration values are in the same risk level, a few sampling points whose methane concentration values do not belong to the same risk level may be determined as burrs.

It may be understood that after independent sub-slices corresponding to the burrs are determined, each sub-segment is segmented. Specifically, values at different risk levels are segmented according to the risk level, values at the same risk level are segmented according to a time threshold. Based on a time interval between adjacent sampling points being greater than the time threshold, the sub-segment is segmented into different sub-slices, or the sub-segment is processed according to one sub-slice. The time threshold may be but is not limited to one day.

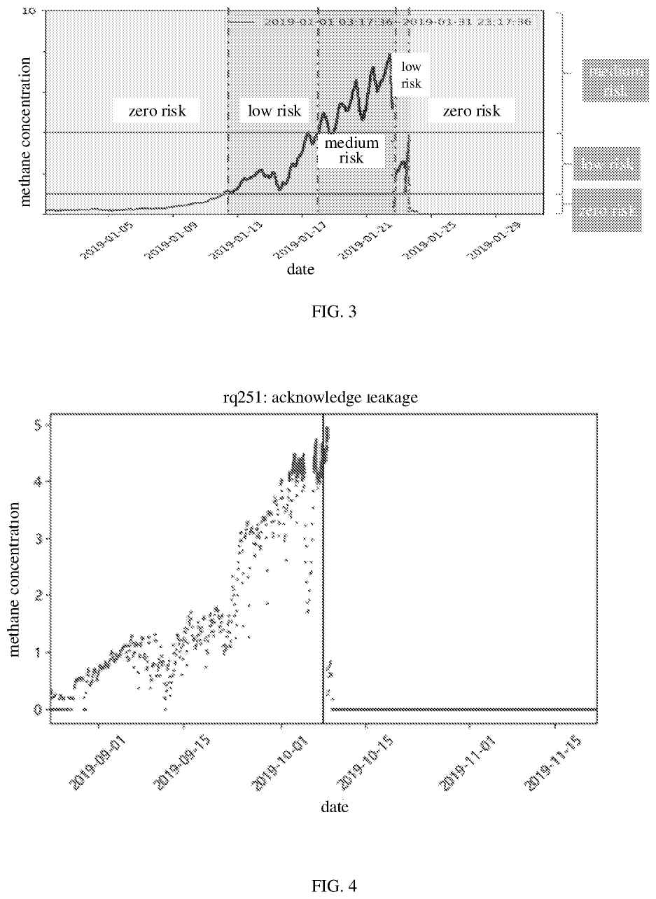

In summary, the plurality of methane concentration sequences obtained by segmenting the first methane concentration sequence are divided according to different risk levels, and sub-slices corresponding to the different risk levels are determined. Then, an example diagram of unit segments whose methane concentration changes abnormally is obtained as shown in FIG. 3, based on an end time of the first candidate methane concentration sequence segment corresponding to the highest risk level (e.g., a segment corresponding to a medium risk in FIG. 3), and a start time corresponding to the second candidate methane concentration sequence segment with a risk level of zero (e.g., a segment corresponding to a zero risk in FIG. 3), whose start time is before a start time of the first candidate methane concentration sequence segment and is closest to the start time of the first candidate methane concentration sequence segment. As such, one of the unit segments whose methane concentration changes abnormally may be taken as the target methane concentration sequence. For example, a methane concentration sequence between the start time of a segment corresponding to the zero risk, and the end time of a segment corresponding to the medium risk in FIG. 3 is taken as the target methane concentration sequence, but is not limited to the above.

At step 103, a methane concentration change feature is obtained by performing feature extraction on the target methane concentration sequence segment.

At step 104, a target real methane concentration sequence matching the methane concentration change feature is acquired from a real gas leakage case library.

In embodiments of the present disclosure, the method for acquiring the any one real methane concentration sequence in the real gas leakage case library may include: acquiring, from a timing database, a second methane concentration sequence different from the first methane concentration sequence; obtaining a plurality of methane concentration sequence segments by segmenting the second methane concentration sequence according to a methane concentration interval corresponding to a preset risk level; acquiring a time point acknowledged by a maintenance man for the methane concentration sequence in the plurality of methane concentration sequence segments, and taking the time point as an end time corresponding to the abnormal change of the methane concentration; acquiring, from the plurality of methane concentration sequence segments, a third candidate methane concentration sequence segment with a risk level of zero which is located before the end time and whose start time is closest to the end time; and taking each of the plurality of methane concentration sequence segments located between the start time of the third candidate methane concentration sequence segment and the end time as the real methane concentration sequence.

The time point acknowledged by the maintenance man for the methane concentration sequence is as illustrated in FIG. 4. Scatter points in FIG. 4 are methane concentration values corresponding to different time points, and a vertical line is a time point for acknowledging gas leakage labeled by the maintenance man.

In another embodiments of the present disclosure, in order to enhance the efficiency of acquiring the target real methane concentration sequence matching the methane concentration change feature, for the any one real methane concentration sequence in the real gas leakage case library, the feature extraction may be performed on the real methane concentration sequence, and the extracted methane concentration change feature may be stored in a feature library corresponding to the real gas leakage case library.

In some embodiments, the feature library may further include a service feature, a device personalized index, a basic feature and a coding feature corresponding to the real methane concentration sequence, to match the target real methane concentration sequence with the same methane concentration change feature more accurately.

In some embodiments, basic features corresponding to the first methane concentration sequence may be determined in combination with the first methane concentration sequence. The basic features corresponding to the first methane concentration sequence include a maximum value, an average value and a quantile of the methane concentrations.

In some embodiments, a temperature sequence and a humidity sequence corresponding to the real methane concentration sequence are stored in a timing database.

In order to facilitate processing features corresponding to the temperature sequence and the humidity sequence, basic features corresponding to the temperature sequence and basic features corresponding to the humidity sequence may be stored in the above feature library.

The basic features of the temperature sequence may include, but not limited to, a maximum value, an average value and a quantile of temperatures.

The basic features of the humidity sequence may include, but not limited to, a maximum value, an average value and a quantile of humidifies.

In some embodiments, the real methane concentration sequence consists of each methane concentration sequence segment located between the start time of the third candidate methane concentration sequence segment and the end time. The coding features of the real methane concentration sequence may be obtained based on performing feature extraction on the each methane concentration sequence segment constituting the real methane concentration sequence.

The coding features of the real methane concentration sequence may include, but not limited to, a number of sub-slice segments, risk levels of segments, a minimum duration of segments, a maximum duration of segments, a concentration level corresponding to the minimum duration of the segments, a concentration level corresponding to the maximum duration of the segments, a maximum concentration level, volatility and trend of the segments, presence or absence of pulses, and a pulse degree.

The feature library may further store service features and device personalized indexes, to facilitate subsequent query and use of information such as the service features and the device personalized indexes.

The service features may include periodicity, such as methane concentration levels day and night, methane concentration levels in the morning, noon, evening and other time periods, and methane concentration levels in different months.

The device personalized indexes may include, but not limited to, a number of gas leakages that have occurred in different inspection wells in history, a number of biogas development processes and a number of abnormal changes of methane concentrations in different inspection wells. The number of biogas development processes refers to a number of times when it is determined that there is a biogas in different inspection wells although methane concentrations in the different inspection wells in history are abnormal. At step 105, a gas leakage label corresponding to the target real methane concentration sequence is taken as label data of the target methane concentration sequence segment.

The gas leakage label corresponding to the target real methane concentration sequence may manually label the target real methane concentration sequence.

Leakages in the target real methane concentration sequence may be manually labeled, for example, as shown in FIG. 4.

At step 106, an updated real gas leakage case library is obtained by adding the target methane concentration sequence segment and corresponding label data to the real gas leakage case library.

In the embodiment, for the target methane concentration sequence segment to be labeled, and in combination with a gas leakage label corresponding to the target real methane concentration sequence matching the target methane concentration sequence in the real gas leakage case library, label data corresponding to the target methane concentration sequence segment is accurately determined. Therefore, the target methane concentration sequence segment and the corresponding label data may be accurately determined without necessarily manually labeling the target methane concentration sequence segment to be labeled, which achieves that a manual labeling cost may be reduced while the real gas leakage case library is expanded.

At step 107, the model of identifying gas leakage is trained according to each methane concentration sequence and corresponding label data in the updated real gas leakage case library.

In the method for training the model of identifying urban underground gas leakage according to the disclosure, the target methane concentration sequence segment corresponding to the abnormal change of the methane concentration is determined based on the acquired first methane concentration sequence to be labeled; the methane concentration change feature is obtained by performing feature extraction on the target methane concentration sequence segment; the corresponding target real methane concentration sequence is obtained by matching from the real gas leakage case library; the label data of the target methane concentration sequence segment is determined; the target methane concentration sequence segment and the corresponding label data are added to the real gas leakage case library to train the model of identifying gas leakage. As such, training the model of identifying gas leakage based on the target methane concentration sequence segment and the corresponding label data enhances the accuracy of identifying the gas leakage, expands the labels of the real gas leakage case library and reduces the cost of manual labeling.

On the basis of the above embodiment, in order to further enhance the efficiency of the model of identifying gas leakage that satisfies requirements, before the real gas leakage case library is expanded, the model of identifying gas leakage may be trained in combination with a manually labeled real gas leakage cases in the real gas leakage case library. That is, before the model of identifying gas leakage is trained according to the each methane concentration sequence and the corresponding label data in the updated real gas leakage case library, the model of identifying gas leakage may also be trained according to the each methane concentration sequence and the corresponding label data in the real gas leakage case library.

In embodiments of the disclosure, in order to accurately identify the urban underground gas leakage, after the model of identifying gas leakage is trained, for each monitoring point in the urban underground, the methane concentration sequence monitored at the monitoring point may be input into the model of identifying gas leakage for identification, and it may be determined whether the monitoring point is in a gas leakage state according to an identification result. That is, whether the gas leakage occurs at the monitoring point is determined according to the identification result.

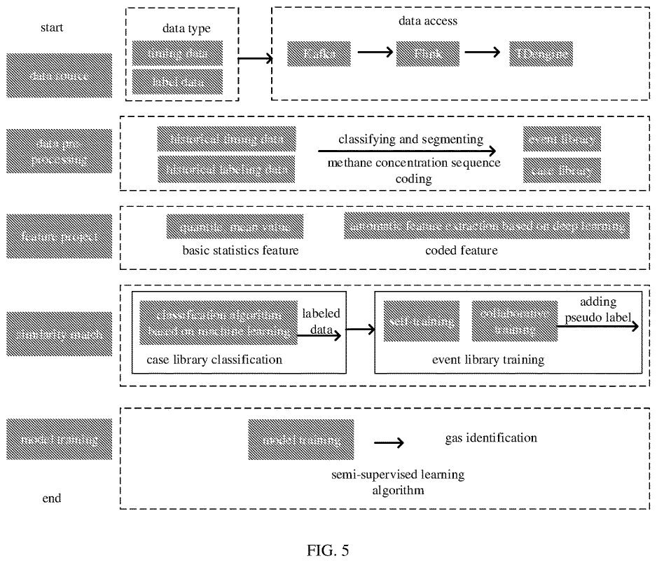

In some embodiments, the method for training the model of identifying urban underground gas leakage based on AIoT may be illustrated in FIG. 5, and a training process is described in combination with FIG. 5.

In some embodiments, a data source monitored by an intelligent hardware device arranged in an inspection well near a gas pipe section in the urban underground gas pipe network may be acquired from a gas big data base platform, timing data and label data in the data source may be transmitted to a kafka cluster for data type conversion, data of the same data type may be input into an offline computing frame Flink for processing, and may be further stored in a timing database TDengine. Also, historical timing data and historical labeling data may be acquired from the timing database TDengine, the acquired historical timing data and the historical labeling data may be coded according to a risk level corresponding to the methane concentration and are segmented according to the risk level to determine a corresponding event library and a corresponding case library. The feature extraction is performed on the quantile, the mean value and other features of the historical timing data based on deep learning to determine the methane concentration change feature corresponding to the historical timing data. Then, historical labeling data with the same methane concentration change feature as the historical timing data is matched on the basis of a machine learning classification algorithm, label data corresponding to the historical labeling data is obtained, and the label data is taken as pseudo label data corresponding to the historical timing data, and is added into a case library. Finally, on the basis of a semi-supervised learning algorithm, a model of identifying gas leakage is trained using the historical labeling data and the corresponding pseudo label data, to accurately identify whether the historical timing data is leaked, which increases pseudo labels of the case library, and reduces the cost of manual labeling.

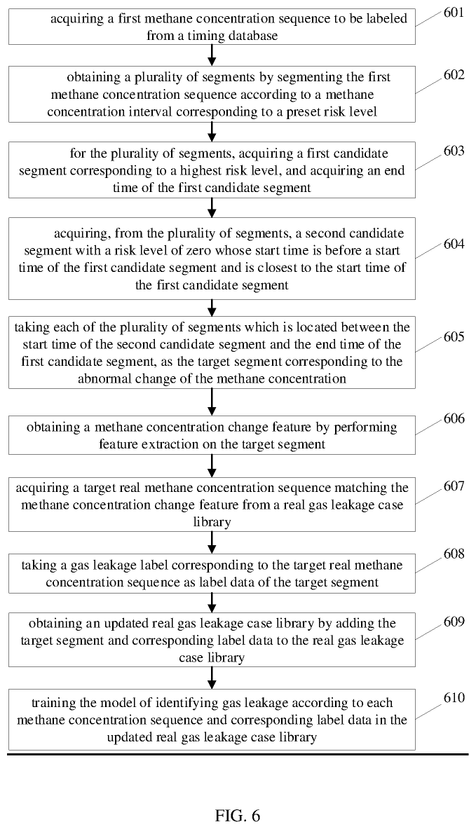

In order to accurately determine the target methane concentration sequence segment corresponding to the abnormal change of the methane concentration, FIG. 6 is a flowchart illustrating a method for training a model of identifying urban underground gas leakage according to another embodiment of the present disclosure. As illustrated in FIG. 6, the method may further include steps 601 to 610.

At step 601, a first methane concentration sequence to be labeled is acquired from a timing database.

At step 602, a plurality of methane concentration sequence segments are obtained by segmenting the first methane concentration sequence according to a methane concentration interval corresponding to a preset risk level.

In embodiments of the disclosure, since the methane concentration is a change process from a safe state to a dangerous state, the duration is not the same. Therefore, it is necessary to identify a methane concentration development interval in which the methane concentration has an ascending trend or a grade change, and the methane concentration interval may be segmented according to the preset risk level of the gas alarm service, but is not limited to the above.

The preset risk level may be adjusted according to the actual service condition, which is not specifically defined in the embodiment.

At step 603, for the plurality of methane concentration sequence segments, a first candidate methane concentration sequence segment corresponding to a highest risk level is acquired, and an end time of a first candidate methane concentration sequence segment is acquired.

In embodiments of the disclosure, the highest risk level may be, but not limited to, a medium risk.

In embodiments of the disclosure, the end time of the first candidate methane concentration sequence segment may be, but not limited to, a time at a position where reduction of the highest risk level occurs.

At step 604, a second candidate methane concentration sequence segment with a risk level of zero whose start time is before a start time of the first candidate methane concentration sequence segment and is closest to the start time of the first candidate methane concentration sequence segment, is acquired from the plurality of methane concentration sequence segments.

In embodiments of the disclosure, when the risk level is zero, the risk level may be, but not limited to, a risk level when the methane concentration is 0.

At step 605, each of the plurality of methane concentration sequence segments which is located between the start time of the second target methane concentration sequence segment and the end time of the first candidate methane concentration sequence segment, is taken as the target methane concentration sequence segment corresponding to the abnormal change of the methane concentration.

In embodiments of the present disclosure, each of the plurality of methane concentration sequence segments which is located between the start time of the second target methane concentration sequence segment and the end time of the first candidate methane concentration sequence segment may include a methane concentration sequence segment corresponding to each of a zero risk, a low risk and a medium risk. That is, the target methane concentration sequence segment corresponding to the abnormal change of the methane concentration is determined/ constituted based on the methane concentration sequence segment corresponding to each of the zero risk, the low risk and the medium risk.

At step 606, a methane concentration change feature is obtained by performing feature extraction on the target methane concentration sequence segment.

It needs to be noted that, an implementation of steps 605 to 606 may refer to a related description of the above embodiments.

At step 607, a target real methane concentration sequence matching the methane concentration change feature is acquired from a real gas leakage case library.

In embodiments of the disclosure, an implementation of acquiring, from the real gas leakage case library, the target real methane concentration sequence matching the methane concentration change feature may be, for any one real methane concentration sequence in the real gas leakage case library, matching a methane concentration change feature corresponding to the real methane concentration sequence with a target methane concentration change feature corresponding to the target methane concentration sequence segment; and in response to a matching degree between the methane concentration change feature corresponding to the real methane concentration sequence and the target methane concentration change feature corresponding to the target methane concentration sequence segment being greater than a preset matching degree threshold, determining a methane concentration change rule of the real methane concentration sequence is same as a methane concentration change rule of the target methane concentration sequence segment, and taking the real methane concentration sequence as the target real methane concentration sequence matching the methane concentration change feature.

Based on the matching degree between the methane concentration change feature corresponding to the real methane concentration sequence and the target methane concentration change feature corresponding to the target methane concentration sequence segment being less than the preset matching degree threshold, the target real methane concentration sequence may be further determined manually.

At step 608, a gas leakage label corresponding to the target real methane concentration sequence is taken as label data of the target methane concentration sequence segment.

At step 609, an updated real gas leakage case library is obtained by adding the target methane concentration sequence segment and corresponding label data to the real gas leakage case library.

At step 610, the model of identifying gas leakage is trained according to each methane concentration sequence and corresponding label data in the updated real gas leakage case library.

In the method for training the model of identifying urban underground gas leakage in embodiments of the disclosure, based on the first methane concentration sequence to be labeled acquired, the plurality of methane concentration sequence segments are obtained by segmenting the first methane concentration sequence according to the methane concentration interval corresponding to the preset risk level; the first candidate methane concentration sequence segment corresponding to the highest risk level is acquired, and the end time of the first candidate methane concentration sequence segment is acquired; and the second candidate methane concentration sequence segment is acquired with a risk level of zero whose start time is before a start time of the first candidate methane concentration sequence segment and is closest to the start time of the first candidate methane concentration sequence segment; and each of the plurality of methane concentration sequence segments which is located between the start time of the second target methane concentration sequence segment and the end time of the first candidate methane concentration sequence segment is taken as the target methane concentration sequence segment corresponding to the abnormal change of the methane concentration; the methane concentration change feature is obtained by performing feature extraction on the target methane concentration sequence segment; the corresponding target real methane concentration sequence is matched from the real gas leakage case library; the label data of the target methane concentration sequence segment is determined; and the target methane concentration sequence segment and the corresponding label data are added to the real gas leakage case library to train the model of identifying gas leakage. As such, the model of identifying gas leakage is trained based on the target methane concentration sequence segment and the corresponding label data. By fine-grained segmentation of the methane concentration sequence, the real methane concentration sequence is accurately determined, and the accuracy of identifying the gas leakage is improved.

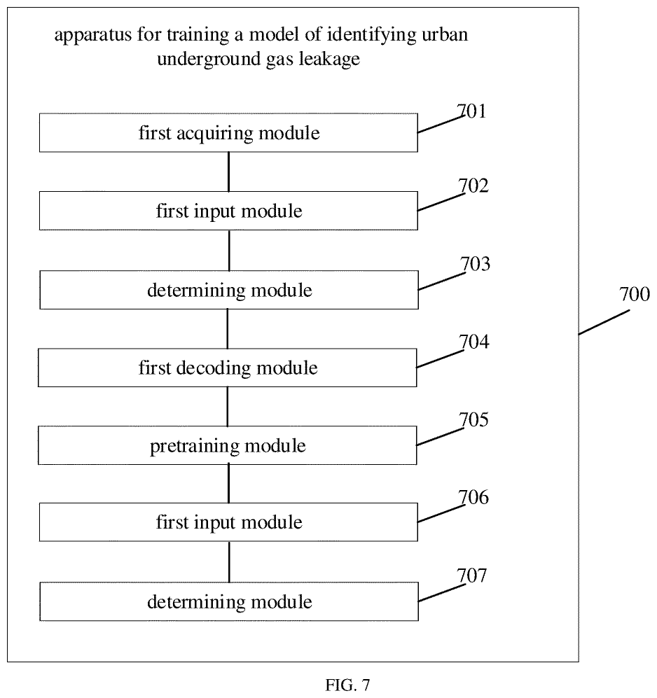

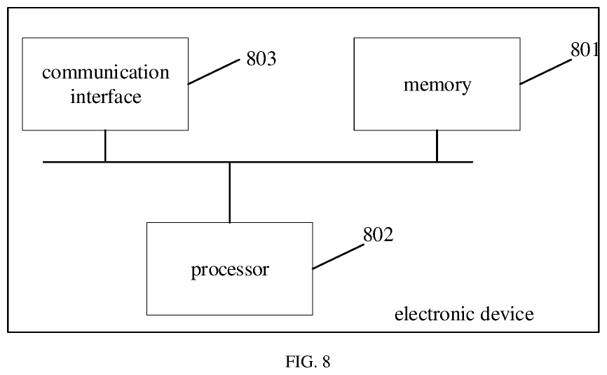

FIG. 7 is a structural diagram illustrating an apparatus for training a model of identifying urban underground gas leakage according to an embodiment of the present disclosure. As illustrated in FIG. 7, an apparatus 700 for training the model of identifying urban underground gas leakage may include a first acquiring module 701, a determining module 702, an extraction module 703, a second acquiring module 704, a generation module 705, an adding module 706 and a first training module 707.

The first acquiring module 701 is configured to acquire a first methane concentration sequence to be labeled from a timing database.

The determining module 702 is configured to determine a target methane concentration sequence segment corresponding to an abnormal change of a methane concentration from the first methane concentration sequence.

The extraction module 703 is configured to obtain a methane concentration change feature by performing feature extraction on the target methane concentration sequence segment.

The second acquiring module 704 is configured to acquire a target real methane concentration sequence matching the methane concentration change feature from a real gas leakage case library.

The generation module 705 is configured to take a gas leakage label corresponding to the target real methane concentration sequence as label data of the target methane concentration sequence segment.

The adding module 706 is configured to obtain an updated real gas leakage case library by adding the target methane concentration sequence segment and corresponding label data to the real gas leakage case library.

The first training module 707 is configured to train the model of identifying gas leakage according to each methane concentration sequence and corresponding label data in the updated real gas leakage case library.

As a possible implementation of embodiments of the present disclosure, the apparatus for training the model of identifying urban underground gas leakage further includes a second training module.

The second training module is configured to train the model of identifying gas leakage according to the each methane concentration sequence and the corresponding label data in the real gas leakage case library.

As a possible implementation of embodiments of the present disclosure, the determining module 702 is specifically configured to:
obtain a plurality of methane concentration sequence segments by segmenting the first methane concentration sequence according to a methane concentration interval corresponding to a preset risk level;
for the plurality of methane concentration sequence segments, acquire a first candidate methane concentration sequence segment corresponding to a highest risk level, and acquire an end time of a first candidate methane concentration sequence segment;
acquire, from the plurality of methane concentration sequence segments, a second candidate methane concentration sequence segment with a risk level of zero whose start time is before a start time of the first candidate methane concentration sequence segment and is closest to the start time of the first candidate methane concentration sequence segment; and
take each of the plurality of methane concentration sequence segments which is located between the start time of the second target methane concentration sequence segment and the end time of the first candidate methane concentration sequence segment, as the target methane concentration sequence segment corresponding to the abnormal change of the methane concentration.

As a possible implementation of embodiments of the disclosure, any one real methane concentration sequence in the real gas leakage case library is acquired by:
acquiring, from the timing database, a second methane concentration sequence different from the first methane concentration sequence;
obtaining a plurality of methane concentration sequence segments by segmenting the second methane concentration sequence according to a methane concentration interval corresponding to a preset risk level;
acquiring a time point acknowledged by a maintenance man for the methane concentration sequence in the plurality of methane concentration sequence segments, and taking the time point as an end time corresponding to the abnormal change of the methane concentration;
acquiring, from the plurality of methane concentration sequence segments, a third candidate methane concentration sequence segment with a risk level of zero which is located before the end time and whose start time is closest to the end time; and
taking each of the plurality of methane concentration sequence segments located between the start time of the third candidate methane concentration sequence segment and the end time as the real methane concentration sequence.

As a possible implementation of embodiments of the present disclosure, the second acquiring module 704 is specifically configured to:
for any one real methane concentration sequence in the real gas leakage case library, match a methane concentration change feature corresponding to the real methane concentration sequence with a target methane concentration change feature corresponding to the target methane concentration sequence segment; and
in response to a matching degree between the methane concentration change feature corresponding to the real methane concentration sequence and the target methane concentration change feature corresponding to the target methane concentration sequence segment being greater than a preset matching degree threshold, determine a methane concentration change rule of the real methane concentration sequence is same as a methane concentration change rule of the target methane concentration sequence segment, and take the real methane concentration sequence as the target real methane concentration sequence matching the methane concentration change feature.

In the apparatus for training the urban underground model of identifying gas leakage according to embodiments of the disclosure, based on the first methane concentration sequence to be labeled acquired, the target methane concentration sequence segment corresponding to the abnormal change of the methane concentration is determined; the methane concentration change feature is obtained by performing feature extraction on the target methane concentration sequence segment; the corresponding target real methane concentration sequence is matched from the real gas leakage case library; the label data of the target methane concentration sequence segment is determined; the target methane concentration sequence segment and the corresponding label data are added to the real gas leakage case library to train the model of identifying gas leakage. As such, the model of identifying gas leakage is trained based on the target methane concentration sequence segment and the corresponding label data, which enhances the accuracy of identifying the gas leakage, expands the label of the real gas leakage case library and reduces the cost of manual labeling.

In order to achieve the above embodiment, an electronic device is further provided in the disclosure. FIG. 8 is a structural diagram illustrating an electronic device according to an embodiment of the present disclosure.

The electronic device includes a memory 801, a processor 802 and a computer program stored on the memory 801 and executable by the processor 802.

The processor 802 implements the method for training the model of identifying urban underground gas leakage according to the above embodiment in the present disclosure.

In some embodiments, the electronic device further includes a communication interface 803, the memory 801 and the processor 802.

The communication interface 803 is configured for communication between the memory 801 and the processor 802.

The memory 801 is configured to store a computer program executable by the processor 802.

The memory 801 may contain a high speed RAM memory, or may include a non-volatile memory, for example, at least one disk memory.

The processor 802 is configured to implement the method for training the model of identifying urban underground gas leakage according to the above embodiment in the present disclosure.

The memory 801, the processor 802 and the communication interface 803 are implemented independently, the communication interface 803, the memory 801 and the processor 802 may be inter-connected via a bus to complete communication between each other. The bus may be an industry standard architecture (ISA) bus, a peripheral component (PCI) bus and an extended industry standard architecture (EISA) bus, etc. The bus may be divided into an address bus, a data bus, a control bus, etc. For ease of representation, only one thick line is used to represent the bus in FIG. 8, but does not represent that there is only one bus or one type of bus.

In some embodiments, in an implementation, if the memory 801, the processor 802 and the communication interface 803 are integrated on one chip and implemented, the memory 801, the processor 802 and the communication interface 803 may be inter-communicated via an internal interface.

The processor 802 may be a central processing unit (CPU), or an application specific integrated circuit (ASIC), or one or more integrated circuits configured to implement embodiments of the present disclosure.

In order to achieve the above embodiments, a computer-readable storage medium storing a computer program is provided according to embodiments of the present disclosure. When the program is executed by the processor, the method for training the model of identifying urban underground gas leakage according to the above any one embodiment of the present disclosure is implemented.

In order to achieve the above embodiments, a computer program product including a computer program is provided according to embodiments of the disclosure. When the computer program is executed by the processor, the method for training the model of identifying urban underground gas leakage according to the above any one embodiment of the present disclosure is implemented

In order to achieve the above purpose, a computer program storing a computer program code is provided according to embodiments of the disclosure. When the computer program code runs on a computer, the computer is caused to perform the method for training the model of identifying urban underground gas leakage according to the above any one embodiment of the disclosure.

It needs to be noted that, the foregoing explanation on the above method and the above apparatus, and the electronic device is also applicable to the above readable storage medium, the above computer program product and the above computer program, which will not be repeated here.

In descriptions of the specification, descriptions with reference to terms “one embodiment”, “some embodiments”, “examples”, “specific examples” or “some examples” etc. mean specific features, structures, materials or characteristics described in conjunction with the embodiment or example are included in at least one embodiment or example of the present disclosure. The exemplary expressions of the above terms throughout this specification are not necessarily referring to the same embodiment or example of the disclosure. Moreover, specific features, structures, materials or characteristics described may be combined in any one or more embodiments or examples in a suitable manner. In addition, those skilled in the art may combine different embodiments or examples with characteristics of different embodiments or examples described in this specification without contradicting each other.

In addition, terms such as “first” and “second” are used herein for purposes of description and are not intended to indicate or imply relative importance or significance. Thus, the feature defined with “first” and “second” may explicitly and implicitly include at least one such feature. In the description of the present disclosure, “a plurality of” means at least two, for example two, three, etc., unless otherwise specified.

Any process or method descriptions described in the flowchart or in other ways herein may be understood as a module, a segment or a part of a code including one or more executable instructions configured to implement steps of customized logical functions or processes, and the scope of embodiments of the present disclosure include additional implementations where functions may not be implemented in the order shown or discussed including the substantially simultaneous manner according to functions involved or in reverse order, which should be understood by those skilled in the art of embodiments of the present disclosure.

The logics and/or steps described in other manners herein or shown in the flow chart, for example, a particular sequence table of executable instructions for realizing the logical function, may be specifically achieved in any computer readable medium to be used by the instruction execution system, apparatus or device (such as the system based on computers, the system comprising processors or other systems capable of obtaining the instruction from the instruction execution system, apparatus or device and executing the instruction), or to be used in combination with the instruction execution system, apparatus or device. As to the specification, “the computer readable medium” may be any device adaptive for including, storing, communicating, propagating or transferring programs to be used by or in combination with the instruction execution system, apparatus or device. A more specific example of a computer readable medium (a non-exhaustive list) includes the followings: an electronic connector (an electronic device) with one or more cables, a portable computer disk box (a magnetic device), a random access memory (RAM), a read-only memory (ROM), an erasable programmable read-only memory (an EPROM or a flash memory), an optical fiber device, and a portable optical disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the disclosure may be realized by hardware, software, firmware or their combination. In the above implementation, steps or methods may be stored in a memory and implemented by software or firmware executed by a suitable instruction execution system. For example, if implemented with hardware, they may be implemented by any of the following techniques or their combination known in the art as in another implementation: a discrete logic circuit with logic gate circuits configured to achieve logic functions on data signals, a special integrated circuit with appropriate combined logic gate circuits, a programmable gate array (PGA), a field programmable gate array (FPGA), etc.

It may be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual function units in the embodiments of the disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The storage medium mentioned above may be read-only memories, magnetic disks or CD, etc. Although explanatory embodiments have been shown and described, it would be appreciated by those skilled in the art that the above embodiments cannot be construed to limit the disclosure, and changes, alternatives, and modifications can be made in the embodiments without departing from the scope of the disclosure.

All embodiments of the disclosure may be executed separately or in combination with other embodiments, and are deemed within a protection scope of the disclosure.

1. A method for training a model of identifying gas leakage, comprising:
acquiring a first methane concentration sequence to be labeled from a timing database;
determining a target segment corresponding to an abnormal change of a methane concentration from the first methane concentration sequence;
obtaining a methane concentration change feature by performing feature extraction on the target segment;
acquiring a target real methane concentration sequence matching the methane concentration change feature from a real gas leakage case library;
taking a label corresponding to the target real methane concentration sequence as label data of the segment;
obtaining an updated real gas leakage case library by adding the target segment and the label data to the real gas leakage case library; and
training the model of identifying gas leakage according to each methane concentration sequence and corresponding label data in the updated real gas leakage case library.

2. The method according to claim 1, wherein before training the model of identifying gas leakage according to the each methane concentration sequence and the corresponding label data in the updated real gas leakage case library, the method further comprises:
training the model of identifying gas leakage according to the each methane concentration sequence and the corresponding label data in the real gas leakage case library.

3. The method according to claim 1, wherein determining the target segment corresponding to the abnormal change of the methane concentration from the first methane concentration sequence comprises:
obtaining a plurality of segments by segmenting the first methane concentration sequence according to a methane concentration interval corresponding to a preset risk level;
for the plurality of segments, acquiring a first candidate segment corresponding to a highest risk level, and acquiring an end time of the first candidate segment;
acquiring, from the plurality of segments, a second candidate segment with a risk level of zero whose start time is before a start time of the first candidate segment and is closest to the start time of the first candidate segment; and
taking each of the plurality of segments which is located between the start time of the second candidate segment and the end time of the first candidate segment, as the target segment corresponding to the abnormal change of the methane concentration.

4. The method according to claim 1, wherein any one real methane concentration sequence in the real gas leakage case library is acquired by:
acquiring, from the timing database, a second methane concentration sequence different from the first methane concentration sequence;
obtaining a plurality of segments by segmenting the second methane concentration sequence according to a methane concentration interval corresponding to a preset risk level;
acquiring a time point acknowledged by a maintenance man for the second methane concentration sequence in the plurality of segments, and taking the time point as an end time corresponding to the abnormal change of the methane concentration;
acquiring, from the plurality of segments, a third candidate segment with a risk level of zero which is located before the end time and whose start time is closest to the end time; and
taking each of the plurality of segments located between the start time of the third candidate methane concentration sequence segment and the end time as the real methane concentration sequence.

5. The method according to claim 1, wherein acquiring the target real methane concentration sequence matching the methane concentration change feature from the real gas leakage case library comprises:
for any one real methane concentration sequence in the real gas leakage case library, matching a methane concentration change feature corresponding to the real methane concentration sequence with a target methane concentration change feature corresponding to the target segment; and
in response to a matching degree between the methane concentration change feature corresponding to the real methane concentration sequence and the target methane concentration change feature corresponding to the target segment being greater than a preset matching degree threshold, determining a methane concentration change rule of the real methane concentration sequence is same as a methane concentration change rule of the target segment, and taking the real methane concentration sequence as the target real methane concentration sequence matching the methane concentration change feature.

6.-10. (canceled)

11. An electronic device, comprising
a memory, a processor, and a computer program stored on the memory and executable by the processor, wherein the processor is configured to:
acquire a first methane concentration sequence to be labeled from a timing database;
determine a target segment corresponding to an abnormal change of a methane concentration from the first methane concentration sequence;
obtain a methane concentration change feature by performing feature extraction on the target segment;
acquire a target real methane concentration sequence matching the methane concentration change feature from a real gas leakage case library;
take a label corresponding to the target real methane concentration sequence as label data of the target segment;
obtain an updated real gas leakage case library by adding the target segment and the label data to the real gas leakage case library; and
train the model of identifying gas leakage according to each methane concentration sequence and corresponding label data in the updated real gas leakage case library.

12. A non-transitory computer-readable storage medium storing a computer program, wherein when the computer program is executed by a processor, a method for training a model of identifying gas leakage is implemented, the method comprising
acquiring a first methane concentration sequence to be labeled from a timing database;
determining a target segment corresponding to an abnormal change of a methane concentration from the first methane concentration sequence;
obtaining a methane concentration change feature by performing feature extraction on the target segment;
acquiring a target real methane concentration sequence matching the methane concentration change feature from a real gas leakage case library;
taking a label corresponding to the target real methane concentration sequence as label data of the target segment;
obtaining an updated real gas leakage case library by adding the target segment and the label data to the real gas leakage case library; and
training the model of identifying gas leakage according to each methane concentration sequence and corresponding label data in the updated real gas leakage case library.

13. (canceled)

14. (canceled)

15. The electronic device according to claim 11, wherein the processor is further configured to:
train the model of identifying gas leakage according to the each methane concentration sequence and the corresponding label data in the real gas leakage case library.

16. The electronic device according to claim 11, wherein the processor is further configured to:
obtain a plurality of segments by segmenting the first methane concentration sequence according to a methane concentration interval corresponding to a preset risk level;
for the plurality of segments, acquire a first candidate segment corresponding to a highest risk level, and acquire an end time of a first candidate segment;
acquire, from the plurality of segments, a second candidate segment with a risk level of zero whose start time is before a start time of the first candidate segment and is closest to the start time of the first candidate segment; and
take each of the plurality of segments which is located between the start time of the second candidate segment and the end time of the first candidate segment, as the target segment corresponding to the abnormal change of the methane concentration.

17. The electronic device according to claim 11, wherein any one real methane concentration sequence in the real gas leakage case library is acquired by:
acquiring, from the timing database, a second methane concentration sequence different from the first methane concentration sequence;
obtaining a plurality of segments by segmenting the second methane concentration sequence according to a methane concentration interval corresponding to a preset risk level;
acquiring a time point acknowledged by a maintenance man for the second methane concentration sequence in the plurality of segments, and taking the time point as an end time corresponding to the abnormal change of the methane concentration;
acquiring, from the plurality of segments, a third candidate segment with a risk level of zero which is located before the end time and whose start time is closest to the end time; and
taking each of the plurality of segments located between the start time of the third candidate methane concentration sequence segment and the end time as the real methane concentration sequence.

18. The electronic device according to claim 11, wherein the processor is further configured to:
for any one real methane concentration sequence in the real gas leakage case library, match a methane concentration change feature corresponding to the real methane concentration sequence with a target methane concentration change feature corresponding to the target segment; and
in response to a matching degree between the methane concentration change feature corresponding to the real methane concentration sequence and the target methane concentration change feature corresponding to the target segment being greater than a preset matching degree threshold, determine a methane concentration change rule of the real methane concentration sequence is same as a methane concentration change rule of the target segment, and take the real methane concentration sequence as the target real methane concentration sequence matching the methane concentration change feature.

19. The storage medium according to claim 12, wherein before training the model of identifying gas leakage according to the each methane concentration sequence and the corresponding label data in the updated real gas leakage case library, the method further comprises:
training the model of identifying gas leakage according to the each methane concentration sequence and the corresponding label data in the real gas leakage case library.

20. The storage medium according to claim 12, wherein determining the target segment corresponding to the abnormal change of the methane concentration from the first methane concentration sequence comprises:
obtaining a plurality of segments by segmenting the first methane concentration sequence according to a methane concentration interval corresponding to a preset risk level;
for the plurality of segments, acquiring a first candidate segment corresponding to a highest risk level, and acquiring an end time of a first candidate segment;
acquiring, from the plurality of segments, a second candidate segment with a risk level of zero whose start time is before a start time of the first candidate segment and is closest to the start time of the first candidate segment; and
taking each of the plurality of segments which is located between the start time of the second candidate segment and the end time of the first candidate segment, as the target segment corresponding to the abnormal change of the methane concentration.

21. The storage medium according to claim 12, wherein any one real methane concentration sequence in the real gas leakage case library is acquired by:
acquiring, from the timing database, a second methane concentration sequence different from the first methane concentration sequence;
obtaining a plurality of segments by segmenting the second methane concentration sequence according to a methane concentration interval corresponding to a preset risk level;
acquiring a time point acknowledged by a maintenance man for the second methane concentration sequence in the plurality of segments, and taking the time point as an end time corresponding to the abnormal change of the methane concentration;
acquiring, from the plurality of segments, a third candidate segment with a risk level of zero which is located before the end time and whose start time is closest to the end time; and
taking each of the plurality of segments located between the start time of the third candidate methane concentration sequence segment and the end time as the real methane concentration sequence.

22. The storage medium according to claim 12, wherein acquiring the target real methane concentration sequence matching the methane concentration change feature from the real gas leakage case library comprises:
for any one real methane concentration sequence in the real gas leakage case library, matching a methane concentration change feature corresponding to the real methane concentration sequence with a target methane concentration change feature corresponding to the target segment; and
in response to a matching degree between the methane concentration change feature corresponding to the real methane concentration sequence and the target methane concentration change feature corresponding to the target segment being greater than a preset matching degree threshold, determining a methane concentration change rule of the real methane concentration sequence is same as a methane concentration change rule of the target segment, and taking the real methane concentration sequence as the target real methane concentration sequence matching the methane concentration change feature.
